(19) United States
(12) Patent Application Publication
(10) Pub. No.: US 2008/0083111 A1
(43) Pub. Date: Apr. 10, 2008

(54) Apparatus and method of producing a microphone assembly

(76) Inventor: Yong Hyun Shim, Incheon (KR)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/899,140

(22) Filed: Sep. 4, 2007

(30) Foreign Application Priority Data
Oct. 10, 2006 (KR) 10-2006-0098389

(51) Int. Cl. H01S 4/00

(52) U.S. Cl. 29/592.1; 29/729; 29/739; 381/384

(57) ABSTRACT

A microphone assembly is provided. An apparatus for fabricating the microphone assembly includes a lower mold attached to a bottom surface of a printed circuit board (PCB) on which a microphone chip is mounted, an upper mold installed on the PCB and including receiving spaces receiving the microphone chips and an inlet for injecting a material; and a material injector movably installed with respect to the inlet to inject epoxy or silicone into the receiving spaces of the upper mold. A method for fabricating the microphone phone includes mounting microphone chips, installing the mold, injecting the material, and cutting the PCB and producing the microphone assembly. The microphone assembly is fabricated in a transfer molding process or an injection molding process using a mold to reduce the processing time needed for fabricating the microphone and fabricating high quality microphones due to improvements in workability and productivity.

### BACKGROUND OF THE INVENTION

1. Field of the Invention

The present invention relates to a microphone assembly of a microphone, and more particularly, to an apparatus and method for fabricating a microphone assembly, which can reduce processing time needed for fabricating a microphone and fabricate a high quality microphone by fabricating the microphone assembly in a transfer molding process or an injection molding process.

2. Description of the Related Art

Generally, a microphone assembly for an electret condenser microphone and a digital microphone is fabricated by mounting a plurality of microphone chips on a printed circuit board (PCB) and then individually cutting the mounted microphone chips.

Referring to FIGS. 1 and 2, a microphone assembly includes a plurality of microphone chips 200 arranged on a PCB 100 and spaced apart from one another by predetermined distances.

Referring to FIGS. 3 and 4, the microphone chips 200 having a predetermined shape, a predetermined area D, and a predetermined height H are fixed to the PCB 100.

The microphone chips 200 fixed to the PCB 100 are encapsulated using silicon or epoxy. A method for fabricating a typical microphone chip 200 will be described below with reference to FIG. 5. A material injector 300 is installed above the microphone chips 200 fixed to the PCB 100. The material injector 300 provides epoxy E toward the microphone chip 200 through an air pressure. In this way, an encapsulation or molding process of the microphone assembly is carried out.

Accordingly, the microphone assembly has the predetermined height H (see FIG. 5), a predetermined shape, and a predetermined area D (see FIG. 6).

In the typical microphone assembly, it is difficult to adjust the shape and height of the molding according to characteristics of the injected silicon or epoxy E. Therefore, it is difficult to produce products at a uniform quality. Furthermore, it is difficult to realize various shapes of the microphone assembly by only injection of the epoxy E.

In the molding process of the typical microphone assembly, since precision of the molding size is lowered, it is difficult to secure a back-chamber of the microphone. Therefore, quality of the microphone is degraded and a change of sensitivity is difficult. In addition, since the process of molding the microphone chips is complicated, processing time required for fabricating the microphone increases, leading to reduction of productivity.

### SUMMARY OF THE INVENTION

Accordingly, the present invention is directed to an apparatus and method for fabricating a microphone assembly that substantially obviates one or more problems due to limitations and disadvantages of the related art.

An object of the present invention is to provide a microphone assembly fabricated in a transfer molding process or an injection molding process to reduce the processing time needed for fabricating the microphone, fabricate high quality microphones due to improvements in the workability and productivity, and obtain the needed back-chamber by changing the shape of the microphone, thereby changing the sensitivity of the microphone.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purposes of the invention, as embodied and broadly described herein, there is provided an apparatus for fabricating a microphone assembly, including: a lower mold attached to a bottom surface of a printed circuit board (PCB) on which a microphone chip is mounted; an upper mold installed on the PCB and including receiving spaces receiving the microphone chips and an inlet through which a material is injected; and a material injector movably installed with respect to the inlet to inject epoxy or silicon into the receiving spaces of the upper mold.

The upper mold is attached to the PCB and the receiving spaces of the upper mold covers outside of the microphone chips to form independent individual spaces.

The receiving spaces of the upper mold are formed in various shapes to variously form a molding shape of the microphone assembly.

The upper mold is formed in a continuous concave-convex shape to form a plurality of receiving spaces on the PCB and the microphone chips are received in the receiving spaces connected to each other.

The upper mold includes a material channel formed between a lower portion of protrusion portion and the PCB to inject a material injected from the inlet formed at one side of a front end of the material channel along the material channel such that the microphone chips are molded in order.

According to another aspect of the present invention, there is provided a method for fabricating a microphone assembly, including the steps of: (S10) mounting microphone chips uniformly arranged with a predetermined distance from each other on a PCB having a predetermined area; (S20) installing a lower mold attached to a bottom surface of the PCB and an upper mold on the PCB to dispose an upper mold such that receiving spaces of the upper mold receives the microphone chips mounted on the PCB to inject a material into the receiving spaces; (S30) filling the material into the receiving spaces of the upper mold to mold the microphone chips by injecting the material through an inlet of the upper mold using a material injector filled with one of epoxy and silicone; and (S40) cutting the PCB on which the molding is cured into an individual microphone chip unit to fabricate a microphone assembly.

In the operation (S20), the upper mold is attached to the PCB and the receiving spaces of the upper mold covers outsides of the microphone chips to form an independent individual space.

In the operation (S30), the material injector is installed in a vertical direction with respect to the upper mold to inject the material in a vertical downward direction through the inlet.

In the operation (S20), the upper mold is formed in a continuous concave-convex shape to form a plurality of receiving spaces on the PCB and the microphone chips are received in the receiving spaces connected to each other.

In the operation (S30), the material injector is horizontally installed at one side of a front end of the upper mold and injecting the material through the inlet of the upper mold in a lateral direction to mold the microphone chips in order.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a plan view of a typical microphone assembly having a plurality of microphone chips mounted on a printed circuit board;

FIG. 2 is a front view of the typical microphone assembly of FIG. 1;

FIG. 3 is an enlarged view of a portion A of FIG. 1;

FIG. 4 is an enlarged view of a portion B of FIG. 2;

FIG. 5 is a view illustrating a method of fabricating a microphone assembly according to the related art;

FIG. 6 is a plan view of the microphone assembly of FIG. 5;

FIG. 7 is a view illustrating a method of fabricating a microphone assembly according to the present invention;

FIG. 8 is a view of a material injector that is separated from a mold after injecting a material;

FIG. 9 is a view illustrating a method of fabricating a microphone assembly according to another embodiment of the present invention; and

FIG. 10 is a flowchart illustrating a method of fabricating the microphone assembly according to the present invention.

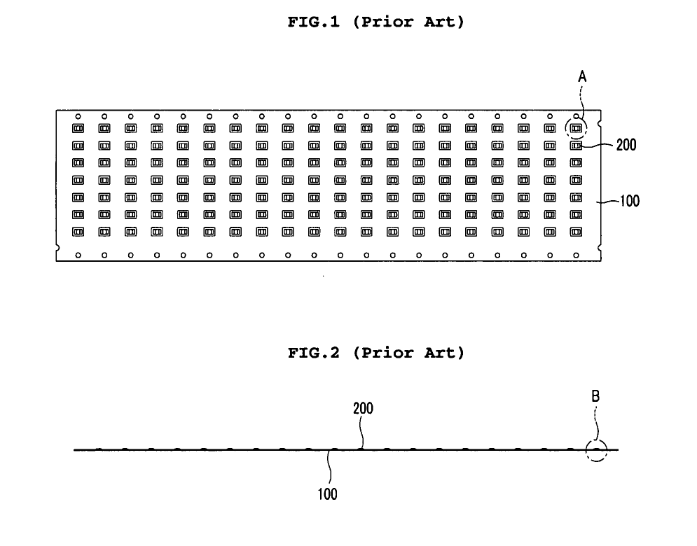

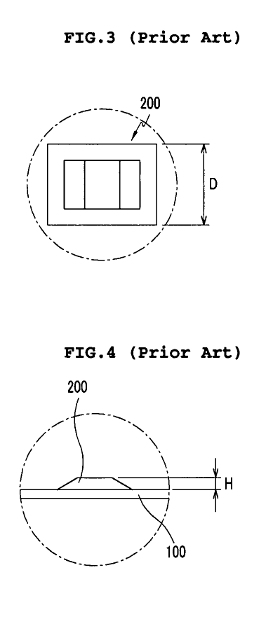

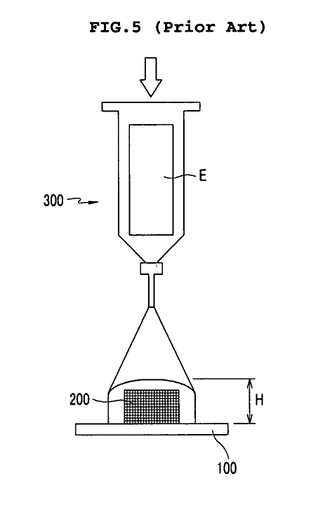

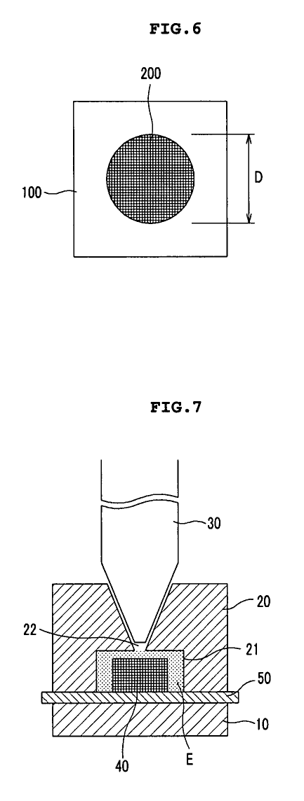

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

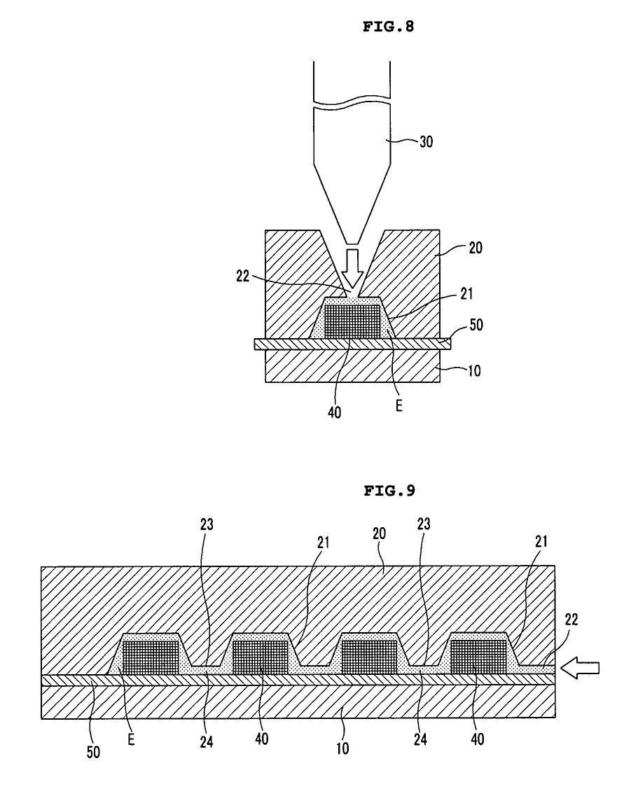

Referring to FIGS. 7 and 8, a microphone assembly for an electret condenser microphone (ECM) and a digital microphone is fabricated by an apparatus using a mold. The apparatus for fabricating the microphone assembly includes a lower mold 10, an upper mold 20, and a material injector 30.

The lower mold 10 is attached to a bottom surface of a printed circuit board (PCB) 50, where a microphone chip 40 is mounted, and supports the PCB 50. The upper mold 20 is installed on the PCB 50 and includes a receiving space 21 and an inlet 22. The receiving space 21 for receiving the microphone chip 40 is formed at lower portion of the upper mold 20. The inlet for injecting the material is formed at an upper portion of the upper mold 20.

The material injector 30 is formed movably up and down with respect to the inlet 22 of the upper mold 20 to inject the material such as epoxy E, silicone or other material into the receiving space 21 of the upper mold 20.

The fabricating apparatus injects the material into the upper mold 20 by a high temperature and a pressure of the material to form a mold around the microphone chip 40.

The fabricating apparatus has various features in the upper mold 20. The upper mold 20 is attached to the PCB 50 and the receiving space 21 covers the outside of the microphone chip 40 to form an independent individual space. The material is injected into the receiving space having one microphone chip 40.

The receiving space 21 of the upper mold 21 is formed in various shapes, for example, square, rectangular, trapezium, etc. Hence, the mold of the fabricated microphone assembly is formed in various shapes to easily change a shape of the microphone.

Accordingly, the needed back-chamber is obtained by changing the shape of the microphone to allow the microphone to change the sensitivity.

Referring to FIG. 9, a fabricating apparatus includes a lower mold 10, an upper mold 20, and a PCB 50. A lower portion of the upper mold 20 has a continuous concave-convex shape to form a plurality of receiving spaces 21 on the PCB 50. The receiving spaces 21 are connected to each other, and microphone chips 40 arranged in series are received in the receiving spaces 21, respectively.

Material channels 24 are formed between a lower portion of protrusion portions 23 of the upper mold 20 and the PCB 50. An inlet 22 is formed at one side of a front end of the material channels 24. The material injected into the inlet 22 flows along the material channels 24 to mold the microphone chips 40 in order.

The upper mold 20 of the fabricating apparatus can have various locations and shapes of the inlet 22 and the material channels 24 according to a kind of appliance to be fabricated.

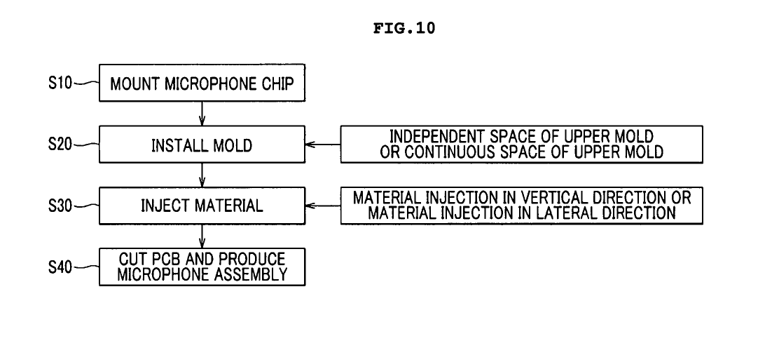

The method for fabricating the microphone assembly will be described below with reference to FIG. 10. The method includes: (S10) mounting a microphone chip; (S20) installing a mold; (S30) injecting a material; and (S40) cutting a PCB and producing the microphone assembly.

More specifically, in operation S10, a plurality of microphone chips are mounted on the PCB having a predetermined width and arranged spaced apart from one another by predetermined distances. In operation S20, a lower mold is attached to a bottom surface of the PCB and an upper mold is installed on the PCB. A receiving space of the upper mold receives the microphone chip mounted on the PCB. The upper mold is disposed such that a material is injected around the received microphone chip. In operation S30, the material is injected through an inlet of the upper mold using a material injector filled with one of epoxy and silicone to mold the microphone chip by filling the material within the receiving space of the upper mold. In operation S40, the PCB on which cured moldings are mounted is cut into individual microphone chip unit to fabricate the microphone assembly.

In operation S20 of installing the mold, the upper mold is attached to the PCB and the receiving space of the upper mold covers the outside of the microphone chip to form an independent individual space. In operation S30 of injecting the material, the material injector is installed in a vertical direction with respect to the upper mold to inject the material in a vertical downward direction through the inlet. The receiving space of the upper mold is filled with the injected material to mold the microphone chip.

As another embodiment, in operation S20, the upper mold is formed in a continuous concave-convex shape to form a plurality of receiving spaces. The receiving spaces are connected to each other, and microphone chips are received in the receiving spaces, respectively. In operation S30 of injecting the material, the material injector is horizontally installed at one side of a front end of the upper mold. The material is injected through the inlet formed at one side of a front end in a lateral direction to mold the microphone chips in order.

Therefore, the microphone is more easily fabricated through the apparatus and method for fabricating the microphone assembly, thereby improving workability and productivity and producing high quality microphone.

As described above, in the apparatus and method for fabricating the microphone assembly according to the present invention, the microphone assembly is fabricated in a transfer molding process or an injection molding process using a mold to reduce the processing time required for fabricating the microphone and fabricate high quality microphone due to improvement of the workability and productivity. Therefore, the mold of the fabricated microphone assembly is formed in various shapes to easily change a shape of the microphone. Accordingly, the needed back-chamber is obtained by changing the shape of the microphone to allow the microphone to change the sensitivity.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for fabricating a microphone assembly, comprising:
a lower mold (10) attached to a bottom surface of a printed circuit board (PCB) (50) on which a microphone chip (40) is mounted;
an upper mold (20) installed on the PCB (50) and including receiving spaces (21) receiving the microphone chips (40) and an inlet (22) through which a material is injected; and
a material injector (30) movably installed with respect to the inlet (22) to inject epoxy or silicone into the receiving spaces (21) of the upper mold (20).

2. The apparatus of claim 1, wherein the upper mold (20) is attached to the PCB (50) and the receiving spaces (21) of the upper mold (20) cover outside of the microphone chips (40) to form independent individual spaces.

3. The apparatus of claim 2, wherein the receiving spaces (21) of the upper mold (20) are formed in a plurality of shapes to form molding shapes for the microphone assembly.

4. The apparatus of claim 1, wherein the receiving spaces (21) of the upper mold (20) are formed in a plurality of shapes to form molding shapes of the microphone assembly.

5. The apparatus of claim 1, wherein the upper mold (20) is formed in a continuous concave-convex shape to form a plurality of receiving spaces (21) on the PCB (50) and the microphone chips (40) are received in the receiving spaces (21) connected to each other.

6. The apparatus of claim 5, wherein the upper mold (20) includes a material channel (24) formed between a lower portion of protrusion portion (23) and the PCB (50) to inject a material injected from the inlet (22) formed at one side of a front end of the material channel (24) along the material channel (24) such that the microphone chips (40) are molded in order.

7. A method for fabricating a microphone assembly, comprising the steps of:
(S10) mounting microphone chips uniformly arranged with a predetermined distance from each other on a printed circuit board (PCB) having a predetermined area;
(S20) installing a lower mold to a bottom surface of the PCB and an upper mold on the PCB such that receiving spaces of the upper mold receive the microphone chips mounted on the PCB to inject a material into the receiving spaces;
(S30) filling the material into the receiving spaces of the upper mold to mold the microphone chips by injecting the material through an inlet of the upper mold using a material injector filled with one of epoxy and silicone; and
(S40) cutting the PCB on which the molding is cured into an individual microphone chip unit to fabricate a microphone assembly.

8. The method of claim 7, wherein, in the operation (S20), the upper mold is attached to the PCB and the receiving spaces of the upper mold covers outside of the microphone chips to form an independent individual space.

9. The method of claim 8, wherein, in the operation (S30), the material injector is installed in a vertical direction with respect to the upper mold to inject the material in a vertical downward direction through the inlet.

10. The method of claim 7, wherein, in the operation (S30), the material injector is installed in a vertical direction with respect to the upper mold to inject the material in a vertical downward direction through the inlet.

11. The method of claim 7, wherein, in the operation (S20), the upper mold is formed in a continuous concave-convex shape to form a plurality of receiving spaces on the PCB and the microphone chips are received in the receiving spaces connected to each other.

12. The method of claim 11, wherein, in the operation (S30), the material injector is horizontally installed at one side of a front end of the upper mold and injecting the material through the inlet of the upper mold in a lateral direction to mold the microphone chips in order.

13. The method of claim 7, wherein, in the operation (S30), the material injector is horizontally installed at one side of a front end of the upper mold and injecting the material through the inlet of the upper mold in a lateral direction to mold the microphone chips in order.
